(19) United States
(12) Patent Application Publication
(10) Pub. No.: US 2014/0297034 A1
(43) Pub. Date: Oct. 2, 2014

(54) SYSTEM AND METHOD FOR GENERATING TEACHING COMMAND TO CONTROL ROBOT

(71) Applicant: ELECTRONICS AND TELECOMMUNICATIONS RESEARCH INSTITUTE, Daejeon (KR)

(72) Inventor: Hoo Man LEE, Daejeon (KR)

(73) Assignee: ELECTRONICS AND TELECOMMUNICATIONS RESEARCH INSTITUTE, Daejeon (KR)

(21) Appl. No.: 14/231,247

(22) Filed: Mar. 31, 2014

(30) Foreign Application Priority Data
Apr. 1, 2013 (KR) 10-2013-0035421

(51) Int. Cl. B25J 9/16

(52) U.S. Cl. CPC B25J 9/163; Y10S 901/46; Y10S 901/03
USPC 700/253; 901/46; 901/3

(57) ABSTRACT

In order for a control system that interlocks with a teaching data input unit and a robot to control the robot, when teaching data including layer selection information that is input through the teaching data input unit is received, the control system generates a joint space path of a layer of any one of teaching data of a first layer and teaching data of a second layer according to the layer selection information of the teaching data. The control system controls the robot based on the generated joint space path.

### CROSS-REFERENCE TO RELATED APPLICATION

This application claims priority to and the benefit of Korean Patent Application No. 10-2013-0035421 filed in the Korean Intellectual Property Office on Apr. 1, 2013, the entire contents of which are incorporated herein by reference.

### BACKGROUND OF THE INVENTION

(a) Field of the Invention

The present invention relates to a system and method for generating teaching commands to control robots.

(b) Description of the Related Art

As technology develops, consumers want to perform various works through an intelligent device. Therefore, a robot to be developed in the future should have an ability to perform work of various categories or a learning ability to perform new work. In order to efficiently use such a robot, development of simple and intuitive robot teaching technology in which a user teaches new work by transferring a command to the robot and that can use existing work is necessary.

A layer in which teaching of a robot is performed may be divided into two. One is teaching of a path layer that analyzes teaching data by trajectory encoding, and the other is teaching of a task layer that analyzes teaching data by symbolic encoding. The path layer is much used for an industrial robot, wherein teaching contents are analyzed with nonlinear mapping between teaching data and a motor command, and the path layer transfers a command to a servo controller of a motor. The task layer is much used for research of a service robot, and it divides and analyzes taught work into continuity of unit action-recognition, and transfers a command to a superordinate controller of the robot.

A conventional industrial robot has been at a level that teaches an accurate position, i.e., only a path for repeated work. However, a service robot should perform work to correspond to sensor information in a dynamic environment, and thus performs a work through a command in a further abstracted task layer. Teaching of a conventional industrial robot is mostly performed in a path layer through a robot language or a teaching pendant, but it is necessary that a future industrial robot can teach a task layer so as to appropriately cope with various situations.

### SUMMARY OF THE INVENTION

The present invention has been made in an effort to provide a system and method for generating teaching commands to control robots having advantages of being capable of teaching a path layer and a task layer.

An exemplary embodiment of the present invention provides a control system for teaching of a robot by interlocking with a teaching data input unit and the robot.

The control system includes: a teaching data analysis unit that receives teaching data including layer selection information that is input from the teaching data input unit and that analyzes the received teaching data as one of teaching data of a first layer and teaching data of a second layer according to the layer selection information; and a teaching command generator that generates joint path data from one of the teaching data of the first layer and the teaching data of the second layer that is analyzed in the teaching data analysis unit.

The teaching data analysis unit may include: a first layer teaching data analysis unit that analyzes teaching data that is input from the teaching data input unit as a sequence of the first layer through a preset learning algorithm; and a second layer teaching data analysis unit that analyzes teaching data that is input from the teaching data input unit as a robot path at a joint space or a working space of the second layer through an algorithm.

The first layer teaching data analysis unit may include: an encoding unit that receives the teaching data of the first layer that is transmitted from the teaching data input unit, that reduces a dimension of the teaching data, and that performs data encoding; and a decoding unit that decodes the teaching data of the first layer in which encoding is performed in the data encoding unit and that generates task information.

The second layer teaching data analysis unit may include: an encoding unit that receives the teaching data of the second layer that is transmitted from the teaching data input unit and that reduces a dimension of the teaching data; and a data decoding unit that decodes the teaching data of the second layer in which a dimension is reduced in the encoding unit and that generates path information.

The teaching command generator may include: a first layer teaching command analysis unit that converts a sequence of the first layer that is generated in the first layer teaching data analysis unit and that generates joint path data of a robot; and a second layer teaching command analysis unit that converts a sequence of the second layer that is generated in the second layer teaching data analysis unit and that generates joint path data of a robot.

Another embodiment of the present invention provides a method for a control system interlocking with a teaching data input unit and a robot to control the robot.

The method includes: receiving teaching data including layer selection information that is input through the teaching data input unit; generating a joint space path of a layer of any one of teaching data of a first layer and teaching data of a second layer according to the layer selection information of the teaching data; and controlling the robot based on the generated joint space path.

The generating a joint space path may include: reducing and encoding, if the teaching data is teaching data of the first layer, the teaching data of the first layer; generating task information by decoding the encoded teaching data of the first layer; and generating a joint space path of a robot according to the first layer based on the generated task information.

The generating of a joint space path may include: reducing, if the teaching data is teaching data of the second layer, the teaching data of the second layer, decoding the teaching data of the second layer, and generating path information; and generating a joint space path of a robot according to the second layer based on the generated path information.

### BRIEF DESCRIPTION OF THE DRAWINGS

FIG. 1 is a schematic view of a robot teaching control system according to an exemplary embodiment of the present invention.

FIG. 2 is a block diagram illustrating a configuration of a control system according to an exemplary embodiment of the present invention.

FIG. 3 is a block diagram illustrating a configuration of a teaching data analysis unit according to an exemplary embodiment of the present invention.

FIG. 4 is a flowchart illustrating data processing of a teaching data analysis unit according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification, unless explicitly described to the contrary, the word “comprise” and variations such as “comprises” or “comprising” will be understood to imply the inclusion of stated elements but not the exclusion of any other elements.

Hereinafter, a control system for robot teaching in which teaching of a path layer and a task layer is available according to an exemplary embodiment of the present invention will be described with reference to the drawings.

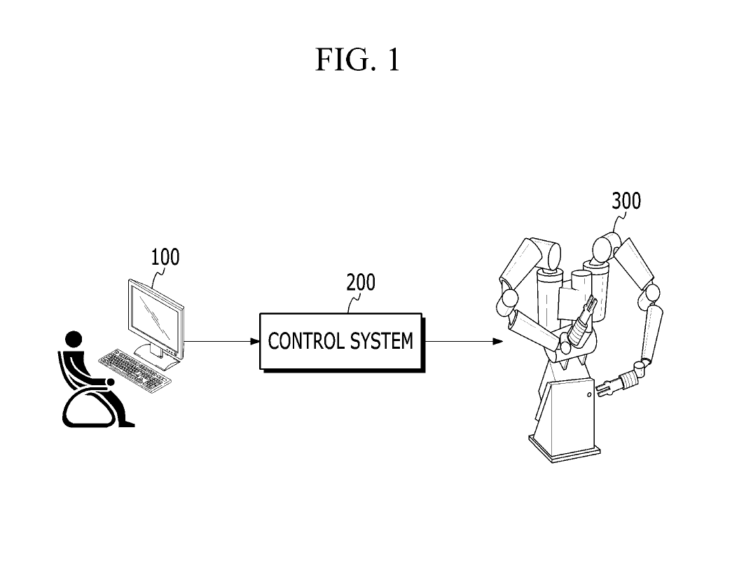

FIG. 1 is a schematic view of a robot teaching control system according to an exemplary embodiment of the present invention.

As shown in FIG. 1, a control system 200 is positioned to interlock with a teaching data input unit 100 in which teaching data is input and a robot 300.

The teaching data input unit 100 that receives teaching data that a teacher inputs and that gives a teaching command to the robot 300 is divided into software and hardware. Software is formed with a software interface such as a robot language and an interpreter, and hardware is formed with a hardware interface such as a motion capture, vision, and data glove.

When the teacher inputs teaching data, the teacher can select a layer to analyze the input teaching data. Therefore, the teaching data includes layer selection information. In addition, information that is included in the teaching data is already known, and thus in an exemplary embodiment of the present invention, a detailed description thereof will be omitted.

The control system 200 generates a task sequence or a robot path based on teaching data and layer selection information that is transferred from the teaching data input unit 100. That is, when the control system 200 receives teaching data of the task layer, the control system 200 generates a sequence of a task, and when the control system 200 receives teaching data of a path layer, the control system 200 generates a robot path and controls a robot, which is a slave. Here, the robot path may be divided into a path of joint space and a path of working space, and a robot which is a slave may be classified into a service robot and an industrial robot, but the robot is not limited thereto. The working space may be a cartesian space.

When continuous teaching data is input, the control system 200 first determines layer selection information and determines whether to transfer data to a teaching data analysis unit of a task layer or to transfer data to a teaching data analysis unit of a path layer. Several data branch methods that determine whether to transfer data may exist, and thus in an exemplary embodiment of the present invention, a detailed description thereof will be omitted. Further, in an exemplary embodiment of the present invention, a system that gives and controls a teaching command to the robot 300 by interlocking with the teaching data input unit 100 and the robot 300 is defined as the control system 200, but may be referred to as another term like a master-slave system including the teaching data input unit 100 and the control system 200.

Here, the control system 200 may be positioned at a remote PC and may be mounted in a robot controller PC for controlling a robot, and a position of a system is not limited to any one.

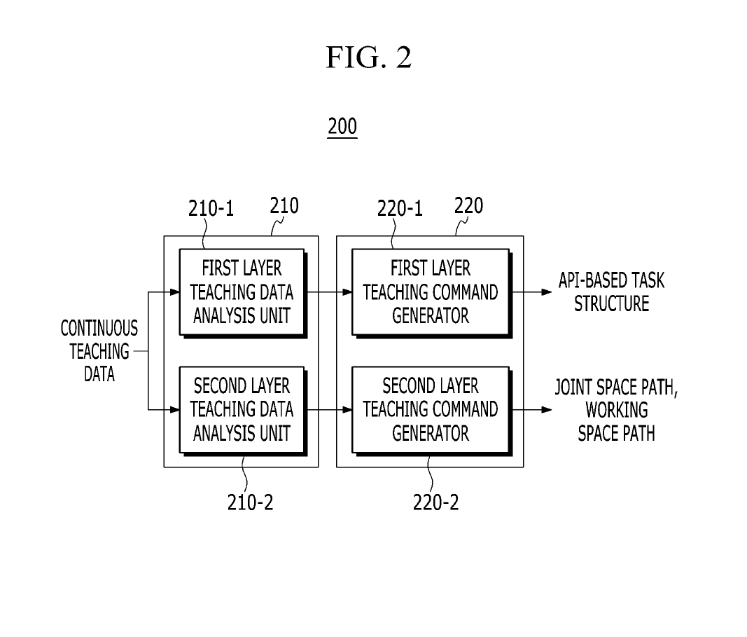

Here, a structure of the control system 200 is described with reference to FIG. 2.

FIG. 2 is a block diagram illustrating a configuration of a control system according to an exemplary embodiment of the present invention.

As shown in FIG. 2, the control system 200 includes a teaching data analysis unit 210 and a teaching command generator 220.

The teaching data analysis unit 210 and the teaching command generator 220 include a first layer teaching data analysis unit 210-1 and a first layer teaching command generator 220-1 of a first layer, which is a task layer, and a second layer teaching data analysis unit 210-2 and a second layer teaching command generator 220-2, respectively, of a second layer, which is a path layer.

The first layer teaching data analysis unit 210-1 analyzes teaching data that is input to the teaching data input unit 100 with a sequence of a task layer, generates a result, and controls the robot 300. In order to analyze teaching data with a sequence of a task, a learning algorithm such as a Gaussian mixture model (GMM) or a hidden Markov model (HMM) is required. A detailed description of a method of analyzing teaching data with a sequence of a task through a GMM or an HMM of the present invention is omitted, and in an exemplary embodiment of the present invention, it is not limited to any one learning algorithm.

The first layer teaching command generator 220-1 converts a sequence of a first layer that is generated in the first layer teaching data analysis unit 210-1 to a command of a form corresponding to the slave 300, i.e., the robot, to apply and generate a sequence of an API-based task structure. For example, when the slave 300 is a service robot, a command of the robot is converted to a form of a task sequence that gives a command in a work unit of the robot. Here, an API-based task structure is already known, and in an exemplary embodiment of the present invention, a detailed description that generates a sequence of a first layer or a structure thereof into a sequence of an API-based task structure will be omitted.

The second layer teaching data analysis unit 210-2 analyzes teaching data that is input in the teaching data input unit 100 with a sequence of a path layer to control the robot 300, and teaching data that is analyzed with teaching of a path layer is analyzed as a robot path at a joint space or a working space. In order to analyze teaching data with a robot path, an algorithm such as inverse kinematics/dynamics is required, and a continuous joint variable value, i.e., a joint variable value such as an angular velocity or angular acceleration to transfer from teaching data to a joint of the robot 300 through such algorithm, is generated. A detailed description of a method of analyzing teaching data through inverse kinematics/dynamics of the present invention with a robot path will be omitted, and in an exemplary embodiment of the present invention, it is not limited to any one learning algorithm.

The second layer teaching command generator 220-2 converts a sequence of a second layer that is generated in the second layer teaching data analysis unit 210-2 to a command of a form corresponding to a slave to apply and generate joint path data or working space path data. For example, when the slave is an industrial robot, the sequence is converted to give a command to a motor path of the robot.

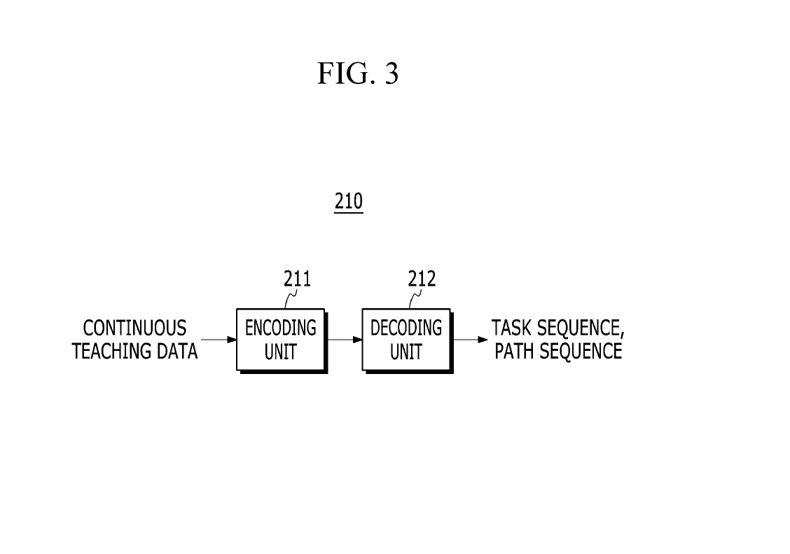

Hereinafter, a structure of the teaching data analysis unit 210 of constituent elements of the control system 200 that is described in the foregoing description will be described with reference to FIG. 3. It is described that the teaching data analysis unit 210 that is shown in FIG. 3 is used by equally applying it to the first layer teaching data analysis unit 210-1 and the second layer teaching data analysis unit 210-2, but the present invention is not limited thereto.

FIG. 3 is a block diagram illustrating a configuration of a teaching data analysis unit according to an exemplary embodiment of the present invention.

As shown in FIG. 3, the teaching data analysis unit 210 includes an encoding unit 211 and a decoding unit 212.

The encoding unit 211 receives teaching data that is input and transmitted by a teacher, reduces a dimension of data, and performs data encoding. Here, for data encoding, the encoding unit 211 encodes teaching data with a probability model such as a GMM or an HMM. A method in which a GMM or an HMM encodes teaching data is already known, and thus in an exemplary embodiment of the present invention, a detailed description thereof will be omitted. Here, when teaching data is teaching data of a path layer, the teaching data is directly transferred to the decoding unit 212 without encoding in the encoding unit 211.

The decoding unit 212 receives task data that is encoded with probability in the encoding unit 211 or path data that is transferred without encoding in the encoding unit 211, and decodes teaching data and generates an optimal task sequence or an optimal path sequence. In order for the decoding unit 212 to generate a task sequence or a path sequence by decoding teaching data, several methods of decoding teaching data may exist, and thus in an exemplary embodiment of the present invention, a detailed description thereof will be omitted. An optimal task sequence or an optimal path sequence that is generated in this way is transferred to the teaching command generator 220 that is described in FIG. 2 to be generated into a sequence of an API-based task structure or to be generated into joint path data or working space path data.

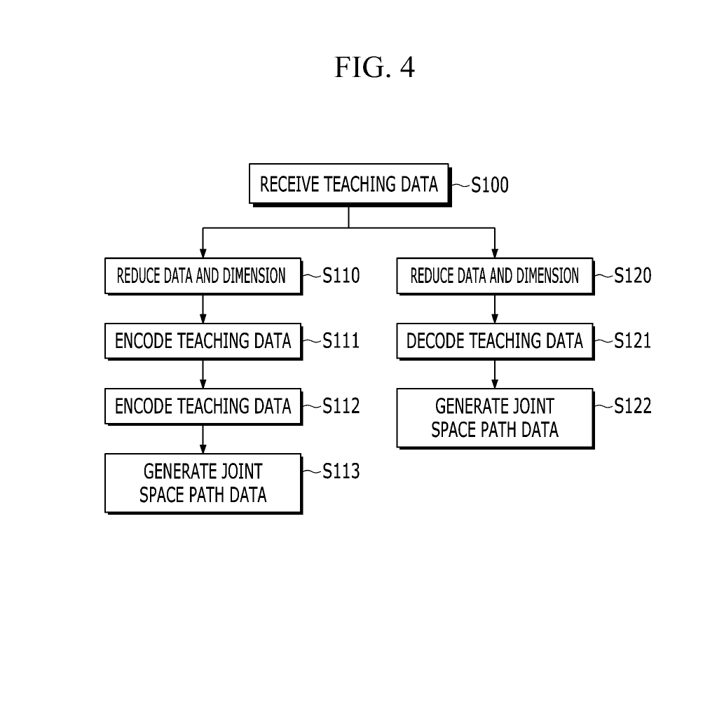

Hereinafter, a procedure in which the teaching data analysis unit 210 that is described in the foregoing description analyzes and processes teaching data will be described with reference to FIG. 4.

FIG. 4 is a flowchart illustrating data processing of a teaching data analysis unit according to an exemplary embodiment of the present invention.

As shown in FIG. 4, when a teacher inputs teaching data through the teaching data input unit 100, the input continuous teaching data are transferred to the encoding unit 211 (S100). In this case, the teaching data includes layer selection information representing whether corresponding teaching data is teaching data of a task layer or teaching data of a path layer.

When teaching data is input, layer selection information is together included in the teaching data, and thus the teaching data analysis unit 210 of the control system 200 is automatically branched to input the input teaching data to a teaching data analysis unit corresponding to layer selection information of the first layer teaching data analysis unit 210-1 or the second layer teaching data analysis unit 210-2.

When layer selection information that is input by the teacher is teaching data of a path layer, the encoding unit 211 of the second layer teaching data analysis unit 210-2 reduces data and a dimension of input teaching data (S120). The encoding unit 211 transfers teaching data in which data and a dimension are reduced to the decoding unit 212, and the decoding unit 212 decodes the received teaching data and generates a path sequence (S121). When the generated path sequence is transferred to the teaching command generator 220, the teaching command generator 220 generates path information into path data of the robot and transmits the path data to control the robot (S122). Here, the path data of the robot is one of a path of joint space and a path of working space.

When layer selection information that is input by the teacher is teaching data of a task layer, the encoding unit 211 of the first layer teaching data analysis unit 210-1 reduces data and a dimension of input teaching data (S110), and encodes teaching data that is reduced to a probability model such as a GMM or an HMM (S111). A method in which the encoding unit 211 reduces data and a dimension of teaching data or a method of encoding teaching data, which is a process that recognizes with a previously defined unit task API through a pattern of teaching data, is already known, and thus in an exemplary embodiment of the present invention, a detailed description thereof will be omitted.

Thereafter, teaching data of a task layer in which encoding is complete in the encoding unit 211 is transferred to the decoding unit 212, and the decoding unit 212 decodes teaching data, which is a process of generating a joint path to perform a corresponding API, and generates a task sequence (S112). When the generated task sequence is transferred to the teaching command generator 220, the teaching command generator 220 generates a task sequence and transmits the task sequence to control a robot (S113).

A task sequence or a path sequence is generally defined as a path of working space. Therefore, in an exemplary embodiment of the present invention, it is exemplified that teaching data of a task layer, which is a first layer, or teaching data of a path layer, which is a second layer, is generated into joint space path data through the teaching command generator 220.

According to the present invention, when teaching a robot, a task layer as well as a path layer can be simultaneously taught.

Further, because a teacher can teach an accurate path of a robot using teaching of a path layer and can teach the robot to work in a dynamic environment using teaching of a task layer, teaching of the robot can be performed in a wide range.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A control system for teaching of a robot by interlocking with a teaching data input unit and the robot, the control system comprising:
a teaching data analysis unit that receives teaching data comprising layer selection information that is input from the teaching data input unit and that analyzes the received teaching data as one of teaching data of a first layer and teaching data of a second layer according to the layer selection information; and
a teaching command generator that generates joint path data from one of the teaching data of the first layer and the teaching data of the second layer that is analyzed in the teaching data analysis unit.

2. The control system of claim 1, wherein the teaching data analysis unit comprises:
a first layer teaching data analysis unit that analyzes teaching data that is input from the teaching data input unit as a sequence of the first layer through a preset learning algorithm; and
a second layer teaching data analysis unit that analyzes teaching data that is input from the teaching data input unit as a robot path at a joint space or a working space of the second layer through an algorithm.

3. The control system of claim 2, wherein the first layer teaching data analysis unit comprises:
an encoding unit that receives the teaching data of the first layer that is transmitted from the teaching data input unit, that reduces a dimension of the teaching data, and that performs data encoding; and
a decoding unit that decodes the teaching data of the first layer in which encoding is performed in the data encoding unit and that generates task information.

4. The control system of claim 2, wherein the second layer teaching data analysis unit comprises:
an encoding unit that receives the teaching data of the second layer that is transmitted from the teaching data input unit and that reduces a dimension of the teaching data; and
a data decoding unit that decodes the teaching data of the second layer in which a dimension is reduced in the encoding unit and that generates path information.

5. The control system of claim 2, wherein the teaching command generator comprises:
a first layer teaching command analysis unit that converts a sequence of the first layer that is generated in the first layer teaching data analysis unit and that generates joint path data of a robot; and
a second layer teaching command analysis unit that converts a sequence of the second layer that is generated in the second layer teaching data analysis unit and that generates joint path data of a robot.

6. The control system of claim 1, wherein the first layer is a task layer, and the second layer is a path layer.

7. A method for a control system interlocking with a teaching data input unit and a robot to control the robot, the method comprising:
receiving teaching data comprising layer selection information that is input through the teaching data input unit;
generating a joint space path of a layer of any one of teaching data of a first layer and teaching data of a second layer according to the layer selection information of the teaching data; and
controlling the robot based on the generated joint space path.

8. The method of claim 7, wherein the generating a joint space path comprises:
reducing and encoding, if the teaching data is teaching data of the first layer, the teaching data of the first layer;
generating task information by decoding the encoded teaching data of the first layer; and
generating a joint space path of a robot according to the first layer based on the generated task information.

9. The method of claim 8, wherein the encoding of the teaching data comprises reducing the teaching data and encoding the teaching data into a probability model using a preset learning algorithm.

10. The method of claim 9, wherein the preset learning algorithm includes any one of a Gaussian mixture model (GMM) and a hidden Markov model (HMM).

11. The method of claim 7, wherein the generating of a joint space path comprises:
reducing, if the teaching data is teaching data of the second layer, the teaching data of the second layer, decoding the teaching data of the second layer, and generating path information; and
generating a joint space path of a robot according to the second layer based on the generated path information.

12. The method of claim 11, wherein the generating of a joint space path further comprises analyzing the second teaching data with a joint space path through an inverse kinematics/dynamics algorithm.
